(19) United States
(12) Patent Application Publication
(10) Pub. No.: US 2014/0299342 A1
(43) Pub. Date: Oct. 9, 2014

(54) Plant Divider

(71) Applicants: Donald Eugene Shull, Middletown, IL (US); Debra Sue Shull-Andrews, Lincoln, IL (US)

(72) Inventors: Donald Eugene Shull, Middletown, IL (US); Debra Sue Shull-Andrews, Lincoln, IL (US)

(21) Appl. No.: 13/986,115

(22) Filed: Apr. 4, 2013

(51) Int. Cl. A01B 1/00

(52) U.S. Cl. CPC A01B 1/00
USPC 172/378

(57) ABSTRACT

A root dividing tool is disclosed, comprising a pair of tubular handles with a forked assembly attached to the end of said tubular handles. The forked end, in a closed position, is pushed into a root ball already removed from the soil. Moving the handles outward causes the forked end to separate and divide the root ball.

### PURPOSE

To divide the root mass of day lilies and other perennial plants that after a number of years grow to a tangled mass.

### NOVEL FEATURE

The tool is also good for pulling unwanted grasses and weeds. To pull weeds the prongs are in the open position when inserted into soil around the weed to be pulled.

### DESCRIPTION

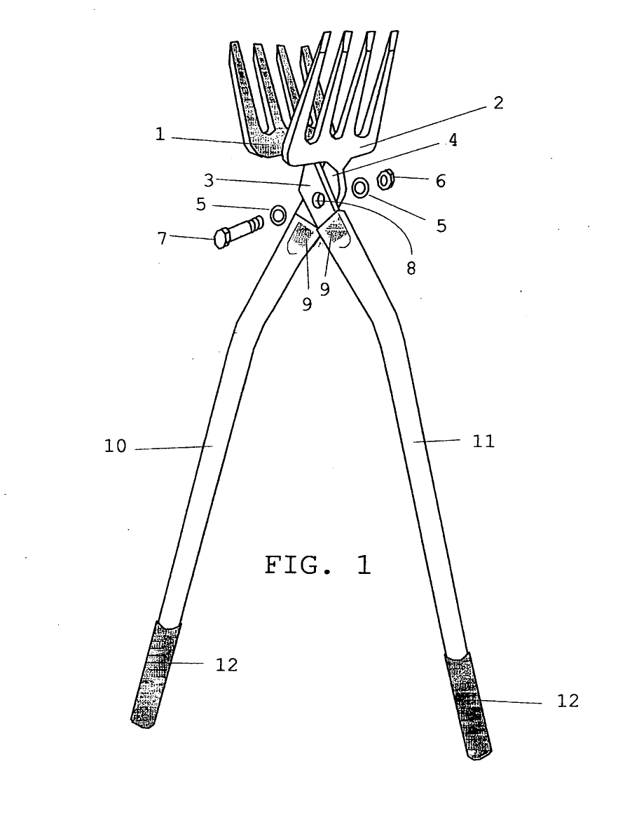

FIG. 1. is a perspective view with reference numerals.

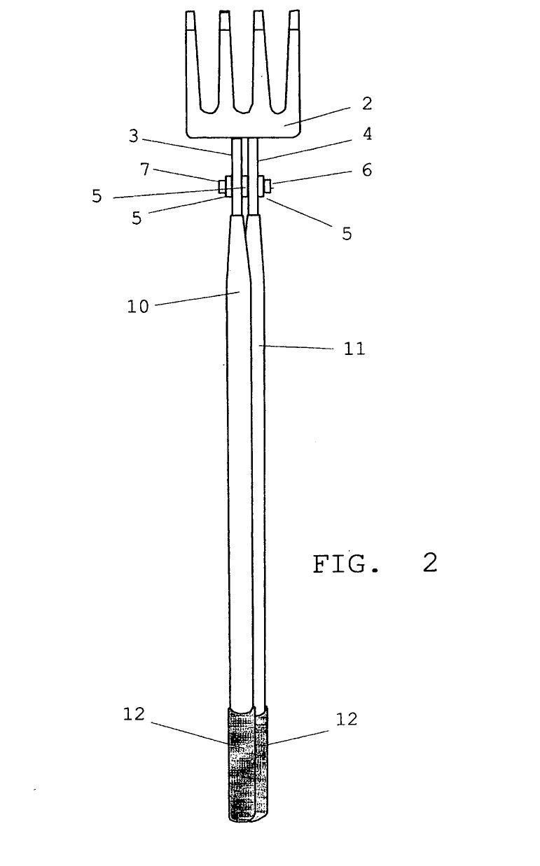

FIG. 2 is perspective view in open position.

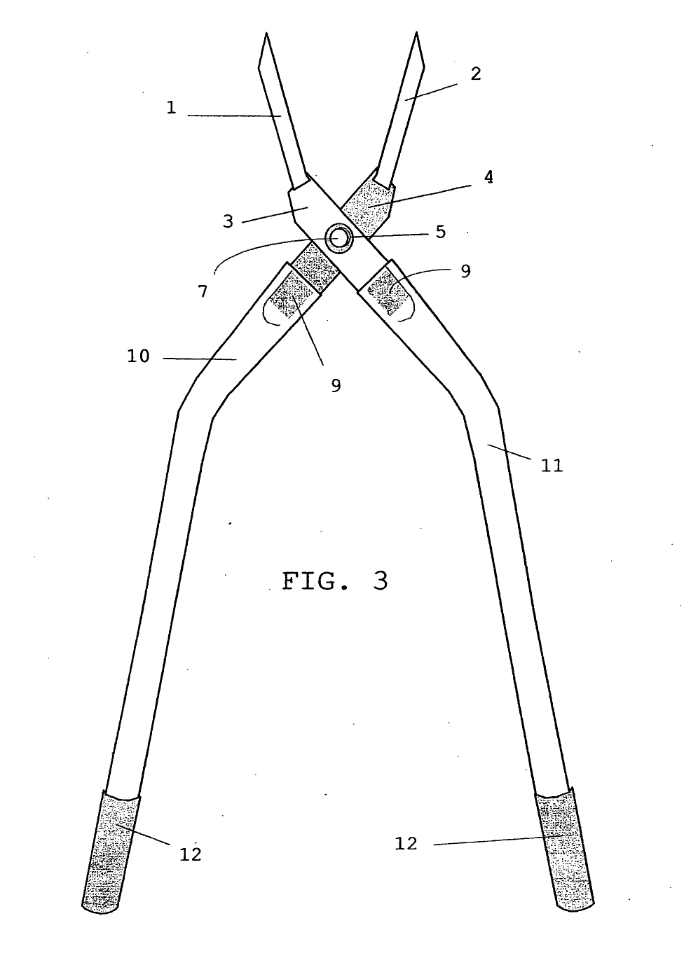

FIG. 3 is a side view.

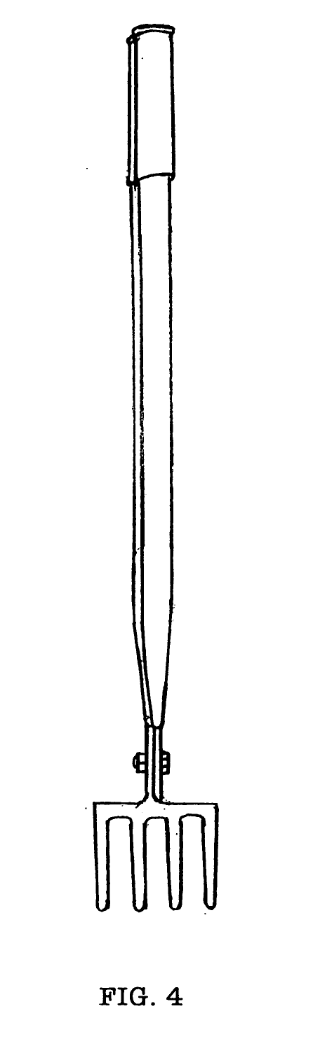

FIG. 4 is a front view.

1. This tool is made for dividing or spreading apart roots of perennial plants.

2. The tool has opposing pointed forks located at the end of tubular handles.

3. The handles intersect near the forked end causing a hinged effect.

4. The forked end, in a closed position, is forced into the rootball of a plant already removed from soil. Pulling the handles apart causes the forked end to move from a closed position to an open position, thus dividing the plant.
